(19) United States
(12) Patent Application Publication
(10) Pub. No.: US 2015/0152983 A1
(43) Pub. Date: Jun. 4, 2015

(54) PRESSURE ARMOR WITH INTEGRAL ANTI-COLLAPSE LAYER

(71) Applicant: DeepFlex Inc., Houston, TX (US)

(72) Inventors: Mark Douglas Kalman, Luthersville, GA (US); Liang Yu, Katy, TX (US)

(21) Appl. No.: 14/407,472

(22) PCT Filed: Jun. 14, 2013
(86) PCT No.: PCT/US2013/045967

§ 371 Date: Dec. 12, 2014

Related U.S. Application Data
(60) Provisional application No. 61/660,212, filed on Jun. 15, 2012.
(60) Provisional application No. 61/753,474, filed on Jan. 17, 2013.

(51) Int. Cl. F16L 11/08

(52) U.S. Cl. CPC F16L 11/085

(57) ABSTRACT

There is provided a flexible pipe, the flexible pipe including a fluid barrier layer, a first pressure armor layer, a second pressure armor layer, and an anti-collapse sheath disposed between the first and second pressure armor layers. The first pressure armor layer may include a metallic interlocked anti-extrusion and hoop strength layer. The second pressure armor may include a hoop strength layer having non-interlocked helical wraps. The second pressure armor layer may include composite helical wraps.

### BACKGROUND

1. Field of the Disclosure

The present disclosure relates to flexible pipe for conveying petroleum or other fluids offshore or on land.

2. Description of the Related Art

A composite armored flexible pipe may be formed, in part, from composite reinforcement tape stacks of laminated tape strips. The composite reinforcement tape stacks may be helically wound without interlocking onto a pipe to provide structure and support. To provide hoop strength, the composite reinforcement tape stacks may be wound at a relatively high lay angle to the pipe axis. Gaps may be present between adjacent wrappings of the tape stacks, to allow for pipe bending. Gaps beyond allowable values may result in blow through of an internal pressure sheath or fluid barrier layer that may be supported by the wrappings. However, advantageously, the gaps may provide flexibility to the wrapped layers so that there may be relative movement between adjacent layers, thereby allowing the pipe to bend. Control over the distance between gaps may be desired so as to prevent blow through of the internal pressure sheath or fluid barrier layer. In addition, an anti-extrusion layer may be applied between the fluid barrier layer and the non-interlocked helical wraps to increase the allowable gap width between the helical wraps.

In metallic armored flexible pipes, interlocking layers or wrappings may be employed as the pressure armor to provide resistance to internal and external pressure and mechanical crushing loads and to prevent blow through of the fluid barrier layer. The interlocked metallic hoop strength layers control gaps by only allowing a maximum separation between adjacent wraps to the full extension of the interlocked wraps, thereby preventing blow through of an internal pressure sheath or fluid barrier layer.

In composite armored flexible pipe, the non-interlocked composite reinforcement tape stacks and anti-extrusion layer may be combined to perform the function of the pressure armor in metallic armored flexible pipe. The anti-extrusion layer may comprise a synthetic fiber reinforced tape.

### SUMMARY

According to one aspect of the present disclosure, there is provided a tubular assembly, the tubular assembly including a fluid barrier layer, and a pressure armor layer, the pressure armor layer including a first layer having at least one metallic layer, the first layer disposed external to the fluid barrier layer, and a second layer having a plurality of composite helical wraps disposed external to the first layer. The composite helical wraps may be non-interlocked.

According to another aspect of the present disclosure, there is provided a flexible pipe, the flexible pipe including a fluid barrier layer, a hoop strength layer having non-interlocked helical wraps, and an anti-extrusion layer including at least one metallic layer, the anti-extrusion layer disposed between the fluid barrier layer and hoop strength layer resists extrusion of the fluid barrier layer into gaps formed between the non-interlocked helical wraps of the hoop strength layer.

According to another aspect of the present disclosure, there is provided a method to prevent extrusion of a fluid barrier layer, the method including disposing an anti-extrusion layer external to a fluid barrier layer of the tubular member, the anti-extrusion layer including at least one metallic layer, and disposing a hoop strength layer external to the anti-extrusion layer of the tubular member.

According to another aspect of the present disclosure, there is provided a flexible pipe, the flexible pipe including a fluid barrier layer, a first pressure armor layer, a second pressure armor layer, and an anti-collapse sheath disposed between the first and second pressure armor layers. The first pressure armor layer may include a metallic interlocked anti-extrusion and hoop strength layer. The second pressure armor may include a hoop strength layer having non-interlocked helical wraps. The second pressure armor layer may include composite helical wraps.

Other aspects and advantages will be apparent from the following description and the appended claims.

### BRIEF DESCRIPTION OF DRAWINGS

Features of the present disclosure will become more apparent from the following description in conjunction with the accompanying drawings.

FIG. 1 shows an isometric view of a flexible pipe in accordance with one or more embodiments of the present disclosure.

FIG. 2 is a cross-sectional view of a flexible pipe in accordance with one or more embodiments of the present disclosure.

FIG. 3 is a cross-sectional view of a flexible pipe in accordance with one or more embodiments of the present disclosure.

FIG. 4 is a cross-sectional view of a flexible pipe in accordance with one or more embodiments of the present disclosure.

FIG. 5 is a cross-sectional view of a flexible pipe in accordance with one or more embodiments of the present disclosure.

FIG. 6 is an isometric view of a flexible pipe in accordance with one or more embodiments of the present disclosure.

### DETAILED DESCRIPTION

A flexible pipe having pressure armor comprising helically wrapped composite and metallic layers will be described herein with reference to the accompanying drawings. The pressure armor performs the functions of increasing the resistance of the flexible pipe to internal and external pressure and mechanical crushing loads, and prevents blow through of the internal pressure sheath or fluid barrier layer. In composite fiber reinforced flexible pipe, the blow through function of the pressure armor may be augmented by an anti-extrusion layer, which bridges the gap between non-interlocked hoop strength, or hoop reinforcement, tape stacks. Thus, the anti-extrusion layer and hoop reinforcement layer are combined to perform the pressure armor function in the flexible pipe.

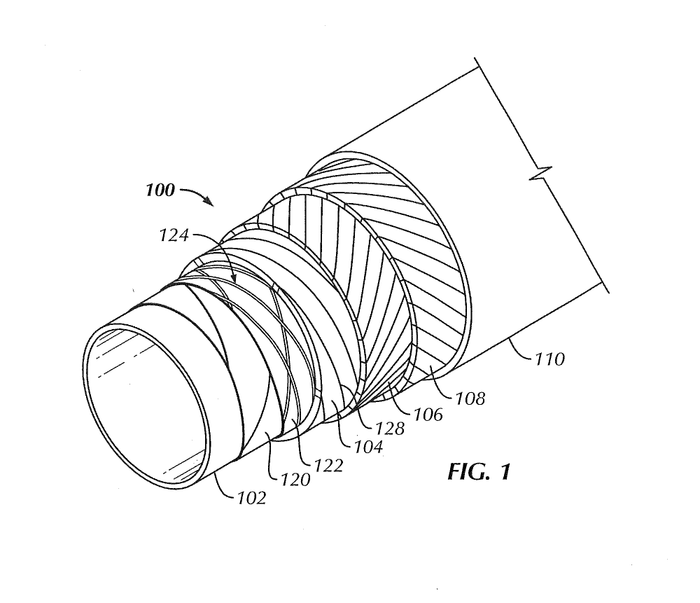

Referring to FIG. 1, an isometric view of a composite fiber reinforced flexible pipe 100 in accordance with one or more embodiments of the present disclosure is shown. In one or more embodiments, a fluid barrier layer 102 (or liner or internal pressure sheath) may be wrapped with a hoop strength layer 104 and tensile reinforcement layers 106 and 108, and may be sealed, covered, and/or protected by a jacket (or outer sheath) 110. Further, in one or more embodiments, an anti-extrusion layer may be included between the fluid barrier layer 102 and the hoop strength layer 104. In one or more embodiments, the anti-extrusion layer may include multiple layers and/or wrappings 120 and 122 of an anti-extrusion material, such as polymer coated fiber reinforced tape, and/or any other high strength tapes known in the art. Further, those skilled in the art will appreciate that the composite flexible pipe 100 may include or be formed from different and/or additional layers, including perforated cores, collapse resistant hoop layers, anti-wear layers, lubricating layers, tensile reinforcement layers, membranes, burst resistant hoop layers, perforated jackets, thermal insulation layers, and/or any other additional layers, or combinations thereof, without deviating from the scope of the present disclosure. The combination of the anti-extrusion layers 120 and 122, and hoop strength layer 104 may perform the function of the pressure armor in flexible pipe, as described in American Petroleum Institute Specification 17B, Recommended Practice for unbonded flexible pipe, which describes both metallic armored and composite armored flexible pipe.

In one or more embodiments, the hoop strength layer 104 may include or be formed from laminated tape stacks, such as disclosed in U.S. Pat. No. 6,491,779, filed on Apr. 24, 2000, entitled “Method of Forming a Composite Tubular Assembly,” U.S. Pat. No. 6,804,942, filed on Sep. 27, 2002, entitled “Composite Tubular Assembly and Method of Forming Same,” U.S. Pat. No. 7,254,933, filed on May 6, 2005, entitled “Anti-collapse System and Method of Manufacture,” and U.S. Patent Application Publication No. 2008/0145583, filed on Dec. 18, 2006, entitled “Free Venting Pipe and Method of Manufacture,” all of which are hereby incorporated by reference in their entireties.

In one or more embodiments, the hoop strength layer 104 may be wound at a “lay angle” relative to a longitudinal axis of the fluid barrier layer 102 or the composite flexible pipe 100, in which higher lay angles may provide relatively higher hoop strength, and lower lay angles may provide relatively higher axial strength. However, in accordance with one or more embodiments of the present disclosure, hoop strength layer 104 may be wound at a relatively high lay angle relative to a longitudinal axis of the pipe, for example between 60° and 89°, to provide internal pressure resistance against burst and/or external pressure resistance against collapse or crushing due to external loads. As noted above, the hoop strength layer 104 may be made from stacks of tape, which may include fibers of glass fiber, aramid, carbon, and/or any other fiber used in composite structural materials.

Further, those skilled in the art will appreciate that the hoop strength layer 104 may include or be formed from steel wire, which may be helically wound at a higher lay angle to provide hoop strength. In one or more embodiments, the steel wire may be rectangular or any other shape that may allow for a higher lay angle. Additionally, although only one hoop strength layer 104 is shown in FIG. 1, those skilled in the art will appreciate that multiple layers or wrappings of hoop reinforcement to provide additional burst, collapse, or crushing resistance may be applied to a pipe without deviating from the scope of the present disclosure. Furthermore, in one or more embodiments, superimposed hoop strength layer, or hoop reinforcement layers, may be counter-wound, such that, for example, one layer may be wound clockwise and a next layer may be wound counter-clockwise, so as to provide and/or improve torsion balance within the pipe.

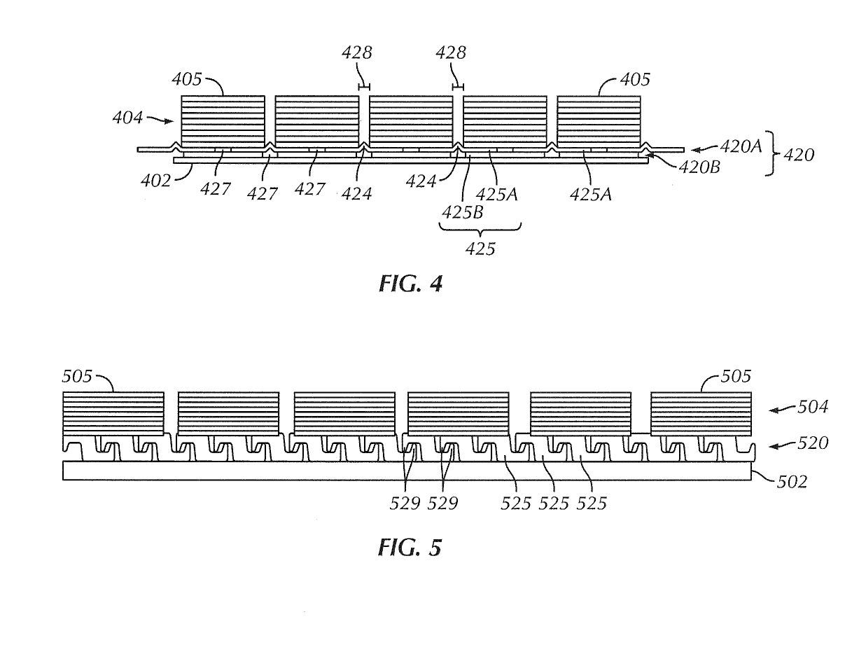

In one or more embodiments, hoop strength layers 104 may have one or more gaps 128 formed between adjacent wrappings of the layer, further discussed below and shown in more detail as gaps 428 in FIG. 4. In one or more embodiments, the gaps 128 may be intentionally produced to a specified width, so as to allow for flexibility within pipe 100. The gaps 128 may vary in width due to imperfect installation within tolerances.

Further, as shown in FIG. 1, anti-extrusion layers 120 and 122 may be applied to a pipe structure such as to resist the fluid barrier layer 102 from flowing into the gaps 128 and/or to prevent blow-through of the fluid barrier layer 102. Multiple anti-extrusion layers may be applied so that stronger blow-through resistance is achieved. Stronger blow through resistance may be required under high internal pressure, such as above 3000 psi design pressure. Stronger blow through resistance may also be required under high internal temperature, such as above 140° F., as the high temperature may result in lower blow through resistance of the fluid barrier layer 102 due to the fluid barrier material being softer or lower in stiffness. As the blow-through resistance, i.e., layers 120 and 122, and any additional layers, are increased in thickness, stiffness and/or strength, the gap 128 may be increased in width, thereby allowing more flexibility in the flexible pipe 100. However, a larger gap 128 may increase the likelihood of blow-through of the fluid barrier layer 102.

Further, although only two anti-extrusion layers 120 and 122 between the fluid barrier layer 102 and the hoop strength layer 104 are shown in FIG. 1, those skilled in the art will appreciate alternative structures may be used without deviating from the scope of the present disclosure. For example, additional anti-extrusion layers, in accordance with one or more embodiments of the present disclosure, or other anti-extrusion layers and/or lubricating layers, may be applied between two hoop strength layers and/or between any superimposed, adjacent, and/or sequentially wrapped layers. For example, an anti-extrusion layer, such as that disclosed in U.S. Patent Application Publication No. 2008/0145583, may be applied, or a lubricating layer and/or anti-wear layer described in American Petroleum Institute Specifications 17J and 17B, which are hereby incorporated in their entireties, may additionally or alternatively be applied. Further, in one or more embodiments, more than one layer may be wrapped and/or applied between pipe structure layers, thereby providing a stronger anti-extrusion layer.

Referring again to FIG. 1, anti-extrusion layers 120 and 122 may provide gap control. A first layer 120 may be helically wrapped around the fluid barrier layer 102. A second layer 122 may be helically wrapped around the first layer 120, but the second layer 122 may be wrapped with an offset from the first layer 120, such that the gaps 128 between adjacent wraps of the first layer 120 may be covered by the second layer 122. Further, the second layer 122 may, at least partially, include or be formed from a material that may allow for at least part of the second layer 122 to displace between adjacent wraps of the hoop layer 104 that may be wrapped over the second layer 122.

The displaced material of the second layer 122 may form a filler 124, which may be displaced bedding material (as described below). The filler 124 may be made of a deformable material, such as that disclosed in U.S. Patent Application Publication No. 2011/0226374, filed on Mar. 17, 2010, entitled “Anti-Extrusion Layer with Non-Interlocked Gap Controlled Hoop Strength Layer,” which is hereby incorporated by reference in its entirety. As shown in FIG. 1, the filler 124 may fill the gaps 128 that form between adjacent wrappings of the hoop strength layer 104.

As shown in FIG. 1, the first and second anti-extrusion layers 120 and 122 may have a rectangular cross section that may be helically wound around the fluid barrier layer 102. In one or more embodiments, the anti-extrusion layers 120 and 122 may be reinforced with uniaxial, twisted, or woven fibers that may provide tensile and/or lateral strength and may be twisted and/or woven. Furthermore, in one or more embodiments, cross fibers may be woven perpendicular to the uniaxial fibers to provide additional strength and/or support.

The anti-extrusion layers 120 and 122 may be partly or entirely metallic. In one or more embodiments, each of the anti-extrusion layers 120 and 122 may include metallic strips, metallic fibers, and/or any other metallic materials known in the art. For example, in one or more embodiments, the anti-extrusion layers 120 and/or 122 may be formed from one or more steel strips. Alternatively, in one or more embodiments, the anti-extrusion layers 120 and/or 122 may be formed from a polymer tape having metallic reinforcement fibers. In one or more embodiments, the reinforcement fibers may be short fibers or long chopped fibers embedded in a polymer matrix, so as to provide appropriate reinforcement to the anti-extrusion layers.

Moreover, although shown as two wrappings of a tape, the anti-extrusion layers 120 and 122 may be a single anti-extrusion layer, such as a single tape wrapping, or may be more than two wrappings, and/or layers or combinations thereof without deviating from the scope of the present disclosure.

According to one or more aspects, a tubular assembly may include a fluid barrier layer, a first layer having at least one metallic layer disposed external to the fluid barrier layer, and a second layer having a plurality of non-interlocked helical wraps disposed external to the first layer. In one or more embodiments, the tubular assembly may be a flexible pipe, the first layer may include an anti-extrusion layer, and the second layer may include a hoop strength layer. In one or more embodiments, the hoop strength layer may resist extrusion of the fluid barrier layer into gaps formed between the non-interlocked helical wraps of the hoop strength layer. In one or more embodiments, the non-interlocked helical wraps may be formed from composite materials, and may be formed from composite reinforcement tape stacks.

In one or more embodiments, there is provided a flexible pipe, the flexible pipe including a fluid barrier layer, a metallic hoop strength layer, or metallic hoop strength layer, and a composite hoop strength layer, or a composite or non-metallic hoop strength layer. The metallic hoop strength layer may be interlocked or non-interlocked. The metallic hoop strength layer may also prevent blow through of the fluid barrier layer. The thickness of each of the metallic and composite hoop strength layers may be adjusted to optimize the design of the flexible pipe. Optimization parameters may include flexible pipe weight, cost and manufacturability.

Referring now to FIG. 2, a cross-section view of a flexible pipe section in accordance with embodiments of the present disclosure is shown. As shown, a metallic helically wrapped layer 220 may be disposed external to a fluid barrier layer 202. In one or more embodiments, the metallic helically wrapped layer may be an anti-extrusion layer. Further, in one or more embodiments, the metallic helically wrapped layer may also be a non-interlocked hoop strength layer, or a combination of anti-extrusion layer and non-interlocked hoop strength layer. In one or more embodiments, a pressure armor may include an interlocked metallic layer, e.g., the metallic helically wrapped layer 20, which may support the internal pressure sheath, e.g., the fluid barrier layer 202, and internal pressure loads applied to the flexible pipe structure.

As shown, a composite hoop strength layer 204 may be disposed external to the layer 220. As discussed above, the fluid barrier layer 202 may be a liner or an internal pressure sheath used to contain fluid. Further, as discussed above, the hoop strength layer 204 may include or be formed from laminated composite tape stacks, which may include fibers of glass fiber, aramid, carbon, high strength steel fiber, and/or any other fiber used in composite structural materials, and may be wound at a lay angle relative to a longitudinal axis of the fluid barrier layer 102 between 60° and 89°. In one or more embodiments, the hoop strength layer 204 may provide internal pressure resistance against burst and/or external pressure resistance against collapse or crushing due to external loads.

Further, as shown in FIG. 2, the metallic helically wrapped layer 220 may include multiple sub-layers 220A, 220B, 220C, and 220D. In one or more embodiments, the layer 220, and each of the sub-layers 220A, 220B, 220C, and 220D that make up the layer 220, may be wrapped around a fluid barrier layer 202. Further, composite reinforcement stacks 205 may form a hoop strength layer 204 helically wrapped over the metallic helically wrapped layer 220. Those having ordinary skill in the art will appreciate that, although the layer 220 shown in FIG. 2 includes four sub-layers, the layer 220, according to embodiments disclosed herein, may not necessarily be limited to four layers. For example, in one or more embodiments, the layer 220 may include one, two, three, four, or more sub-layers without deviating from the scope of the present disclosure.

In one or more embodiments, any one of the sub-layers that make up the layer 220, e.g., sub-layers 220A, 220B, 220C, and 220D, may be a metallic layer. In one or more embodiments, only one of the sub-layers that make up the layer 220 may be a metallic layer. Alternatively, in one or more embodiments, two, three, or more of the sub-layers that make up the layer 220 may be a metallic layer.

In one or more embodiments, the metallic layer may include one or more metallic strips 225. As shown, each of the metallic sub-layers 220A, 220B, 220C, and 220D of the layer 220 includes one or more metallic strips 225. In one or more embodiments, the metallic strips 225 may include steel. However, those having ordinary skill in the art will appreciate that the metallic strips 225 may not necessarily be limited to steel and may be formed from any metal without deviating from the scope of the present disclosure. In one or more embodiments, the metallic layer may be aluminum, titanium, or a corrosion resistant alloy. Alternatively, in one or more embodiments, the at least one metallic layer 220 may include a polymer tape having metallic fibers. For example, an anti-extrusion layer including a polymer tape having metallic fibers may include steel fibers or other metal fibers woven therein. For example, a material such as Bekaert Armofor steel cord reinforced thermoplastic strip may be used for the metallic layer 220. The metallic layer may also be a metallic fabric. For example, the metallic layer may be made from ultra high strength twisted steel wires formed into a steel fabric. For example, the steel fabric sold by Hardwire Composite Armor Systems designated Hardwire Composite Reinforcement.

Further, as discussed above, the layer 220 may include a polymeric or elastomeric coating. Specifically, in one or more embodiments, at least one of the layers that makes up the layer 220 or sub-layers 220A, 220B, 220C, or 220D may include a polymeric coating. In one or more embodiments, the polymer may be an elastomer as described in U.S. Patent Application Publication No. 2011/0226374, which incorporated by reference in its entirety. In one or more embodiments, the polymeric coating, may be an anti-friction layer, and/or an anti-wear layer to improve the flexibility of the pipe and prevent wear of the layer 220 or hoop strength layer 204. For an anti-wear/anti-friction layer, the polymeric coating may be applied to all surfaces of the sub-layers 220A, 220B, 220C or 220D that have relative movement to other sub-layers or layers during pipe bending. In one or more embodiments, the elastomeric or polymeric layer of the layer 220 may prevent damage to the overlying hoop strength layer 204, as well as prevent damage to the underlying fluid barrier layer 202.

In one or more embodiments, one or more gaps 227 may be formed between the metallic strips 225 in the one or more metallic layers of the layer 220. As shown, multiple gaps 227A, 227B, 227C, and 227D are formed between the metallic strips 225 in each of the metallic sub-layers 220A, 220B, 220C, and 220D of the layer 220, respectively. In one or more embodiments, each of the metallic layers that make up the layer 220 may include one, two, three, four, or more metallic strips 225. In one or more embodiments, one or more gaps 227 may be formed in each of the metallic layers that make up the layer 220, as the gaps 227 may be formed between each of the metallic strips 225 in the layer 220.

In one or more embodiments, the gaps 227 formed in a first metallic layer, e.g., the metallic sub-layer 220A, may be offset from a gap 227 that is formed in a second metallic layer, e.g., the metallic sub-layer 220B. For example, as shown, the gap 227A is formed in the first metallic sub-layer 220A and the gap 227B is formed in the second metallic sub-layer 220B. In one or more embodiments, the gap 227A of the first metallic sub-layer 220A may be offset from the gap 227B of the second metallic sub-layer 220B. In other words, in one or more embodiments, there may not be complete overlap of the gap 227A of the first metallic sub-layer 220A and the gap 227B of the second metallic sub-layer 220B, e.g., the gaps 227A and 227B would not be completely aligned. In one or more embodiments, there may be partial overlap between the gap 227A of the first metallic sub-layer 220A and the gap 227B of the second metallic sub-layer 220B. Alternatively, in one or more embodiments, the gaps 227A and 227B may not be aligned and there may be no overlap at all between the gap 227A of the first metallic sub-layer 220A and the gap 227B of the second metallic sub-layer 220B.

Similarly, the gaps 227 formed in a third metallic layer, e.g., the metallic sub-layer 220C, may be offset from a gap 227 that is formed in a fourth metallic layer, e.g., the metallic sub-layer 220D. For example, as shown, the gap 227C is formed in the third metallic sub-layer 220C and the gap 227D is formed in the fourth metallic sub-layer 220D. In one or more embodiments, the gap 227C of the third metallic sub-layer 220C may be offset from the gap 227D of the fourth metallic sub-layer 220D, as well as from the gaps 227A and 227B discussed above.

In other words, in one or more embodiments, there may not be complete overlap between any of the gaps 227, e.g., 227A, 227B, 227C, and 227D. In one or more embodiments, there may be partial overlap, as described above, between one or more of the gaps 227. Alternatively, in one or more embodiments, there may be no overlap at all between one or more of the gaps 227.

In one or more embodiments, the gaps 227 may allow for bending in the layer 220. Specifically, in one or more embodiments, the gaps 227 may provide some clearance for the metallic strips 225 of the layer 220, which may allow the layer 220 to bend while maintaining a structural integrity of the metallic strips 225. However, in one more embodiments, the gaps 227 may not necessarily be necessary in the layer 220. For example, in one or more embodiments, the one or more metallic sub-layers of the layer 220 may be formed without gaps 227 between the metallic strips 225.

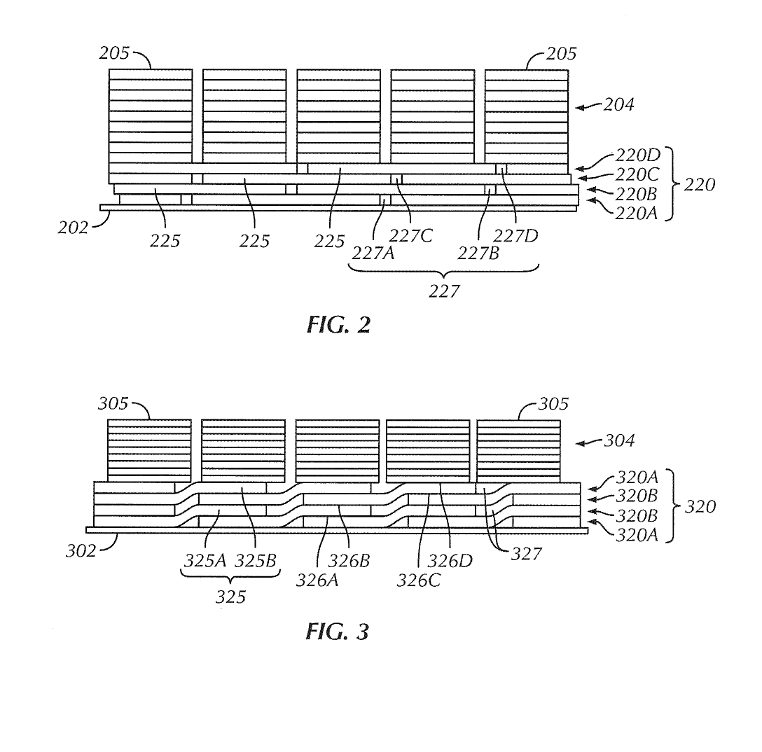

Referring to FIG. 3, a cross-section view of a flexible pipe section in accordance with embodiments of the present disclosure is shown. As shown, a metallic helically wrapped layer 320 may be disposed external to a fluid barrier layer 302. The metallic helically wrapped layer may be an anti-extrusion layer. In one or more embodiments, the metallic helically wrapped layer may also be a non-interlocked hoop strength layer, or a combination of anti-extrusion layer and non-interlocked hoop strength layer. Further, as shown, a hoop strength layer 304 may be disposed external to the layer 320. The hoop strength layer 304 may be formed from composite reinforcement stacks 305.

Further, as shown in FIG. 3, the layer 320 may include multiple sub-layers 320A, 320B, 320C, and 320D. In one or more embodiments, the layer 320, and each of the sub-layers 320A, 320B, 320C, and 320D that make up the layer 320, may be wrapped around the fluid barrier layer 302. Further, hoop strength stacks 305 may form the hoop strength layer 304 of a pipe helically wrapped over the layer 320. As discussed above, those having ordinary skill in the art will appreciate that, although the layer 320 shown in FIG. 3 includes four sub-layers, the layer 320, according to embodiments disclosed herein, may not necessarily be limited to four sub-layers. For example, in one or more embodiments, the layer 320 may include one, two, three, four, or more sub-layers without deviating from the scope of the present disclosure.

As discussed above, in one or more embodiments, the layer 320 may include at least one metallic layer. For example, in one or more embodiments, any one of the layers that make up the layer 320, e.g., sub-layers 320A, 320B, 320C, and 320D, may be a metallic layer.

In one or more embodiments, the metallic layer may include one or more metallic strips 325. As shown, each of the metallic sub-layers 320A, 320B, 320C, and 320D of the layer 320 include a plurality of metallic strips 325. As discussed above, in one or more embodiments, the metallic strips 325 may include steel. However, those having ordinary skill in the art will appreciate that the metallic strips 325 may not necessarily be limited to steel and may be formed from any metal without deviating from the scope of the present disclosure. For example, the metallic layer may be aluminum, titanium or a corrosion resistant alloy.

In one or more embodiments, the metallic strips 325 may include or be formed with a step-shape having a lower portion, e.g., lower portions 326A and 326C, and an upper portion, e.g., upper portions 326B and 326D. In one or more embodiments, a lower portion of one of the step-shaped metallic strips 325 may form a portion of a first metallic layer, e.g., the first metallic sub-layer 320A, and an upper portion of the step-shaped metallic strip 325 may form a portion of a second metallic layer, e.g., the second metallic sub-layer 320B.

For example, as shown, a first step-shaped metallic strip 325A may include a lower portion 326A and an upper portion 326B. As shown, the lower portion 326A forms a portion of the first metallic sub-layer 320A, and the upper portion 326B forms a portion of the second metallic sub-layer 320B. Further, as shown, a second step-shaped metallic strip 325B may include a lower portion 326C and an upper portion 326D. As shown, the lower portion 326C forms a portion of the third metallic sub-layer 320C, and the upper portion 326D forms a portion of the fourth metallic sub-layer 320D. As such, in one or more embodiments, each of the step-shaped metallic strips 325 may form a portion of one or more metallic layers in the layer 320.

Further, in one or more embodiments, one or more gaps 327 may be formed between the step-shaped metallic strips 325. As discussed above, the gaps 327 may allow for bending in the layer 320. However, in one more embodiments, the gaps 327 may not necessarily be included or necessary in the layer 320. For example, in one or more embodiments, the one or more metallic sub-layers of the layer 320 may be formed without gaps 327 between the step-shaped metallic strips 325.

Those having ordinary skill in the art will appreciate that the step-shaped metallic strips 325 may be configured to form a portion of any of the metallic sub-layers of the layer 320, and that the step-shaped metallic strips 325 may not necessarily be limited to forming portions of adjacent metallic layers. For example, in one or more embodiments, one or more of the step-shaped metallic strips 325 may be configured to form a portion of both the first metallic sub-layer 320A and a portion of the third metallic sub-layer 320C or the fourth metallic sub-layer 320D.

Those having ordinary skill in the art will also appreciate that all of the step-shaped metallic strips 325 may not necessarily be identical. For example, in one or more embodiments, one or more of the step-shaped metallic strips 325 may be configured to form a portion of the first metallic sub-layer 320A and the second metallic sub-layer 320B, e.g., the step-shaped metallic strip 325A, while other step-shaped metallic strips 325 may be configured to form a portion of the first metallic sub-layer 320A and the third metallic sub-layer 320C or the fourth metallic sub-layer 320D.

In one or more embodiments, the metallic strips of the layer 320 may include both step-shaped metallic strips, e.g., the step-shaped metallic strips 325, as well as flat metallic strips, e.g., the metallic strips 225 of FIG. 2. For example, in one or more embodiments, the layer 320 may include a combination of both step-shaped metallic strips as well as flat metallic strips.

Referring to FIG. 4, a cross-section view of a flexible pipe section in accordance with embodiments of the present disclosure is shown. As shown, a metallic helically wrapped layer 420 may be disposed external to a fluid barrier layer 402. Further, as shown, a hoop strength layer 404 may be disposed external to the layer 420. In one or more embodiments, the metallic helically wrapped layer 420 may be an anti-extrusion layer. In one or more embodiments, the metallic helically wrapped layer 420 may also be a non-interlocked pressure armor layer, or a combination of anti-extrusion layer and non-interlocked hoop strength layer.

Further, as shown in FIG. 4, the layer 420 includes multiple sub-layers 420A and 420B. In one or more embodiments, the layer 420, and each of the sub-layers 420A and 420B that make up the layer 420, may be wrapped around the fluid barrier layer 402. Further, one or more composite reinforcement stacks 405 may form a hoop strength layer 404 of a pipe helically wrapped over the layer 420. As discussed above, those having ordinary skill in the art will appreciate that the layer 420 may include one, two, three, four, or more sub-layers without deviating from the scope of the present disclosure.

Further, as discussed above, in one or more embodiments, the layer 420 may include at least one metallic layer. For example, in one or more embodiments, any one of the sub-layers that make up the layer 420, e.g., sub-layers 420A and/or 420B may be a metallic layer.

In one or more embodiments, the metallic layer may include one or more metallic strips 425. As shown, each of the metallic sub-layers 420A and 420B of the layer 420 include one or more metallic strips 425. As discussed above, in one or more embodiments, the metallic strips 425 may be made of steel. However, those having ordinary skill in the art will appreciate that the metallic strips 425 may not necessarily be limited to steel and may be formed from any metal without deviating from the scope of the present disclosure. For example, the metallic strip could be formed from aluminum, titanium, or a corrosion resistant alloy.

In one or more embodiments, one or more of the metallic strips 425 may include at least one protrusion 424 formed thereon. In one or more embodiments, the at least one protrusion 424 may be disposed into a space 428 formed between adjacent composite reinforcement stacks 405 of the hoop strength layer 404. For example, as shown, the metallic strips 425A include protrusions 424 formed thereon. Further, as shown, the metallic strips 425 may include flat metallic strips 425B.

In one or more embodiments, the protrusions 424 are formed in the helically wrapped sub-layer 420A, with a spacing slightly larger than the width of the hoop reinforcement stacks 404. Thus, when wrapping the composite tapes 405 to form the hoop reinforcement stacks 404, the spacing between the reinforcement stacks are evenly spaced. Furthermore, when the pipe is subject to bending, the reinforcement stacks 404 will be maintained uniformly spaced when subject to multiple bending cycles. In one or more embodiments, the protrusions 424 may be formed as part of the process in which they are helically wrapped on the pipe.

As discussed above, any combination of metallic strip configurations described herein may be used in an anti-extrusion layer and/or non-interlocked metallic pressure armor layer used in combination with a non-interlocked composite armor layer according to embodiments disclosed herein. For example, in one or more embodiments, the anti-extrusion layer or non-interlocked metallic pressure armor layer may include metallic layers having flat metallic strips, e.g., the metallic strips 225 of FIG. 2, step-shaped metallic strips, e.g., the step-shaped metallic strips 325 of FIG. 3, and/or metallic strips having protrusions formed thereon, such as described in FIG. 4.

Further, as discussed above, gaps 427 may be formed between the metallic strips 425. As discussed above, in one or more embodiments, the gaps 427 may be offset from one another. Further, as discussed above, the gaps 427 may allow for bending in layer 420. However, in one more embodiments, the gaps 427 may not necessarily be included or necessary in the layer 420. For example, in one or more embodiments, the one or more metallic layers of the layer 420 may be formed without gaps 427 between the step-shaped metallic strips 425.

Further, although not shown, in one or more embodiments, the layer 420 of the flexible pipe may include one or more metallic layers formed from one or more metallic strips having protrusions formed thereon. In one or more embodiments, both the metallic layers and the metallic strips may be sufficiently thin such that gaps, as described above, may not necessarily need to be formed in order to allow for bending in the layer 420.

Furthermore, as discussed above, in one or more embodiments, the layer 420 may include a polymeric layer (not shown). The polymeric layer may be an elastomer or a thermoplastic. In one or more embodiments, this polymeric layer may be formed external to one or more metallic layers or sub-layers, as described above, and the hoop strength layer 404 may be disposed external to this polymeric layer. In one or more embodiments, the polymeric layer may be sufficiently deformable such that the polymeric layer acts as a filler, and may fill spaces 428 formed between adjacent wrappings of the hoop strength layer 404. As such, according to one or more embodiments, layer 420 may be used to achieve space control between adjacent stacks of the hoop strength layer 404. In one or more embodiments, the polymeric layer may also perform an anti-wear or anti-friction function, allowing relative movement between the sub-layers 420A and 420B and the layers 420 and 404.

According to another aspect of the present disclosure, there is provided a method for preventing extrusion of a fluid barrier layer of a tubular member. For example, according to one or more aspects of the present disclosure, there is provided a method for preventing blow through of a tubular fluid barrier layer between gaps of a hoop strength layer, with the method including disposing an anti-extrusion layer external to a fluid barrier layer of the tubular member, the anti-extrusion layer comprising at least one metallic layer, and also disposing a composite hoop strength layer external to the anti-extrusion layer of the tubular member.

For example, in one or more embodiments, the method may include installing the anti-extrusion layer on the outer surface of, or external to, the fluid barrier layer of the tubular member. Disposing this anti-extrusion layer having at least one metallic layer may increase the hoop strength of the pipe, and may also prevent the fluid barrier layer from extruding into any spaces that are formed between stacks of the overlying hoop strength layer. In one or more embodiments, the composite hoop strength layer may include non-interlocked helical wraps with gaps formed therebetween.

In one or more embodiments, a metallic interlocked layer may be helically wrapped external to a fluid barrier layer and a composite non-interlocked hoop strength layer may be helically wrapped external to the metallic interlocked hoop strength layer. The metallic interlocked hoop strength layer may provide resistance to blow through of the fluid barrier layer and may also contribute to the hoop strength of the pipe, providing resistance to internal and external pressure as well as external mechanical loads during installation. In one or more embodiments, the composite non-interlocked layer may also provide additional resistance to internal and external pressure and external mechanical loads.

In one or more embodiments, the thickness of each of the metallic interlocked hoop strength layer, as well as the composite non-interlocked layer, may be optimized. For example, in one or more embodiments, the metallic layer may be increased in thickness if it is desired to increase the weight of the pipe to improve pipeline stability or to increase the weight to outer diameter ratio to achieve a desired response to hydrodynamic loading during installation or operation of the flexible pipe. Alternatively, in one or more embodiments, the metallic layer may be relatively thin, such as to improve the manufacturability of the pipe, as it may be difficult to form a thick metallic interlocked layer on smaller diameter pipes, or the forming requirement for a thick layer may exceed the capacity of the manufacturing equipment. Thus, in one or more embodiments, the thickness of both the interlocked and non-interlocked layers can be adjusted to result in a pipe that is manufacturable, or to achieve a desired weight, or to achieve a desired internal pressure resistance or external pressure collapse capacity, or crush resistance, or thermal insulation.

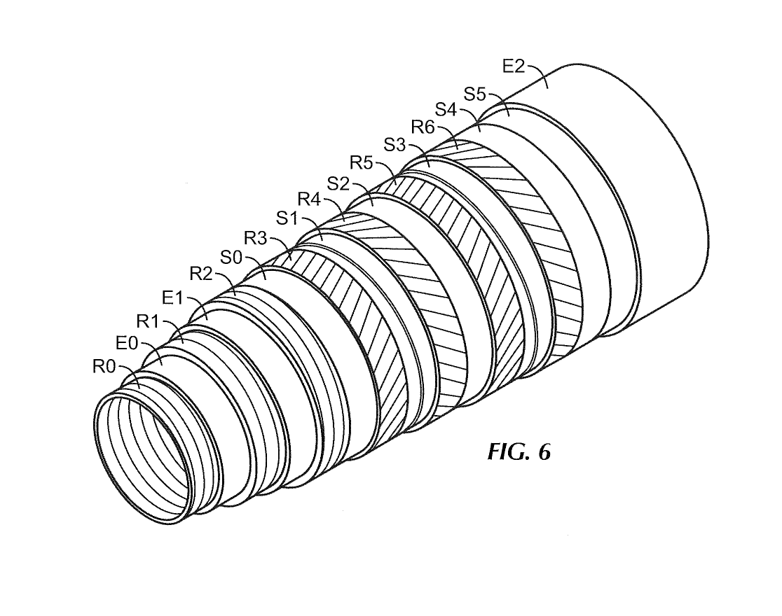

Referring to FIG. 5, a cross-sectional view of a flexible pipe in accordance with embodiments of the present disclosure is shown. As shown, a metallic interlocked helically wrapped layer 520 may be disposed external to a fluid barrier layer 502. Further, as shown, a composite hoop strength layer 504 may be disposed external to the layer 520. As discussed above, the hoop strength layer 504 may include or be formed from laminated composite tape stacks 505, which may include fibers of glass fiber, aramid, carbon, high strength steel fiber, and/or any other fiber used in composite structural materials, and may be wound at a lay angle of 60° to 89°. In one or more embodiments, the metallic interlocked helically wrapped layer 520 may be an anti-extrusion layer. Alternatively, as discussed above, in one or more embodiments, the metallic interlocked helically wrapped layer 520 may also be a non-interlocked hoop strength layer, or a combination of anti-extrusion layer and non-interlocked hoop strength layer.

Further, in one or more embodiments, the layer 520 may include at least one helically wrapped metallic layer. For example, in one or more embodiments, the layer 520 may include one or more sub-layers (not shown), in which one or more of the sub-layers may be a metallic layer. In one or more embodiments, the metallic layer may include one or more metallic shaped wires 525. As discussed above, in one or more embodiments, the metallic shaped wires 525 may be made of steel. However, those having ordinary skill in the art will appreciate that the metallic shaped wires 525 may not necessarily be limited to steel and may be formed from any metal without deviating from the scope of the present disclosure. For example, the metallic strip could be formed from aluminum, titanium, or a corrosion resistant alloy.

In one or more embodiments, each of the metallic shaped wires 525 may include one or more engagement members 529. In one or more embodiments, the engagement members 529 of the metallic shaped wires 525 may be configured to engage with the engagement members 529 of adjacent metallic shaped wires 525 to form the interlocked metallic layer 520. Although one embodiment of the metallic shaped wires 525 that are configured to engage with adjacent metallic shaped wires 525 is shown in FIG. 5, those having ordinary skill in the art will appreciate that other configurations of metallic shaped wire may be used to form an interlocked metallic layer, and this disclosure is not limited to the configuration shown in FIG. 5. For example, in one or more embodiments, the metallic shaped wire may be substantially C-shaped or U-shaped and may be configured to engage with adjacent metallic shaped wires. Alternatively, in one or more embodiments, the metallic strips may be T-shaped or may have a carcass profile and may be configured to engage with adjacent metallic shaped wires or strips. Examples of interlocked pressure armor profiles, in which the metallic shaped wires 525 of the present disclosure may be configured, may be found in the American Petroleum Institute (API) Specification 17B, which is incorporated by reference in its entirety.

Advantageously, a pressure armor layer comprising an anti-extrusion layer having at least one metallic layer in combination with a composite non-interlocked hoop reinforcement layer may provide increased internal pressure capacity, lighter weight and higher resistance to failure mechanisms than prior art pressure armor layers. An all-composite material pressure armor layer employing a composite material anti-extrusion layer and a composite material hoop strength layer may not have sufficient resistance to extrusion of a liner into gaps in the hoop strength layer under high internal pressures and temperatures. The capacity of the anti-extrusion layer employing composite materials to resist extrusion may be limited as a result of lower strain at break, lower elastic modulus, and/or lower creep resistance than metallic materials.

An all-metallic pressure armor layer may be substantially heavier than a pressure armor layer made with a combination of both composite materials and metallic materials. Furthermore, steel materials that are used in the pressure armor layer in flexible pipe may be subject to failure mechanisms including corrosion, hydrogen induced and sulfide stress cracking in applications where the flexible pipe is conveying produced fluids which contain high levels of CO₂ and H₂S, which may permeate into a flexible pipe annulus. However, corrosion-resistant alloys that resist the aforementioned failure mechanisms may be much more expensive and may be challenging to form as a shaped wire and to helically wrap the shaped wire onto the flexible pipe. The helical wrapping process may be particularly challenging for thicker shaped wire sections, which may be required for high pressure applications. Flexible pipe pressure armor employing a relatively thin corrosion-resistant alloy metallic layer, primarily for the anti-extrusion function, and an overlying composite hoop layer, primarily for the internal pressure resistance against burst and/or external pressure resistance against collapse or crushing due to external loads, may overcome these challenges. Thinner corrosion resistant alloy materials may be lower cost and may be easier to form and wrap helically on the pipe. The composite armor materials employed in the hoop strength layer may be selected to be resistant to the aforementioned failure mechanisms.

Thus, by employing metallic materials primarily for the anti-extrusion function, and composite materials primarily for the hoop strength function, the best use of each material's qualities may be employed to make a pressure armor layer that has higher pressure capacity, is lighter in weight, is easier to manufacture, is lower in cost and has improved resistance to failure mechanisms than pressure armor layers which are made only of metallic materials or only of composite materials.

Further, gap control in accordance with one or more embodiments of the present disclosure may provide minimum requirements to prevent blow through. According to the American Petroleum Institute Specification 17J, Table 6, “the maximum allowable reduction in wall thickness (of the internal pressure sheath) below the minimum design value due to creep in(to) the supporting structural layers shall be 30% under all load combinations.” Although this requirement is for conventional flexible pipe, the requirement also applies to flexible fiber reinforced pipe, and is a requirement to prevent blow through of a fluid barrier layer, internal pressure sheath, or liner.

In accordance with one or more embodiments of the present disclosure, hoop strength layers or hoop reinforcement layers, i.e., 104, 204, 304, and 404 of FIGS. 1, 2, 3, and 4, respectively, may be wound at a relatively high lay angle relative to the longitudinal axis of the pipe, e.g., between 60° and 89°, to provide internal pressure resistance against burst and/or external pressure resistance against collapse and resistance against external mechanical loads applied during flexible pipe installation.

Furthermore, one or more embodiments of the present disclosure may provide control over the gaps between adjacent wrappings of a structural layer so as to prevent blow through of a fluid barrier layer or other layer beneath the gap control layer. Further, according to one or more embodiments, an anti-extrusion layer having one or more metallic layers may increase the rigidity of the anti-extrusion layer while also requiring less layers. Accordingly, fewer wrappings and/or applications of anti-extrusion layers may be allowed, thereby increasing the efficiency with which flexible pipes may be formed. Further, fewer wrappings and/or applications may reduce the pipe diameter, thereby reducing costs and weight.

Furthermore, one or more embodiments of the present disclosure may be used with pipes employing internal carcass designs, free venting designs, standard annulus designs, and/or any other pipe designs where blow through prevention or increased structural capacity may be desired, including non-interlocking steel pipe layers. Additionally, gap control layers in accordance with one or more embodiments described herein may be provided between any two consecutively wrapped layers of a pipe.

According to another aspect of the present disclosure, there is provided a flexible pipe, the flexible pipe including a fluid barrier layer, a first pressure armor layer, a second pressure armor layer, and an anti-collapse sheath disposed between the first and second pressure armor layers. The first pressure armor layer may comprise a metallic interlocked anti-extrusion and hoop strength layer, such as defined in API 17J. The second pressure armor may comprise a hoop strength layer having non-interlocked helical wraps. The second pressure armor layer may comprise composite helical wraps. In other words, the flexible pipe, according to embodiments disclosed herein, may include pressure armor with an integral anti-collapse layer. Having a pressure armor with an integral anti-collapse layer may eliminate the need for a separate anti-extrusion layer between a fluid barrier layer and a non-interlocked hoop strength layer. Furthermore, the anti-collapse layer may allow the pressure armor layer disposed on either side of the anti-collapse layer to flex independently. The anti-collapse sheath may allow a metallic pressure armor layer to increase the contribution to pipe collapse capacity, which may increase the water depth rating of the flexible pipe. As such, according to one or more embodiments, the flexible pipe of the present disclosure is not limited to having a separate anti-extrusion layer between a fluid barrier layer and a hoop strength layer.

Referring now to FIG. 6, an isometric view of a flexible pipe 600 in accordance with one or more embodiments of the present disclosure is shown. As shown, the flexible pipe 600 includes a carcass R0, an internal pressure sheath E0, a first pressure armor layer R1, an anti-collapse sheath E1, and a second pressure armor layer R2.

In one or more embodiments, the carcass R0 may be an interlocked metallic construction to prevent collapse of the internal pressure sheath E0. In one or more embodiments, the internal pressure sheath E0 may be a conduit for conveying internal fluid. Further, the first pressure armor layer R1 may be an anti-extrusion layer and may be a metallic layer to provide resistance to internal pressure and mechanical crushing loads (e.g., layers 220, 320, 420, and 520 discussed above). In one or more embodiments, the first pressure armor layer R1 may be an interlocked metallic layer or a non-interlocked metallic layer. For example, in one or more embodiments, the first pressure armor layer R1 may be formed from carbon steel.

In one or more embodiments, the anti-collapse sheath E1 may prevent seawater intrusion into underlying layers, thus allowing a hoop reinforcement layer (e.g., hoop strength layers 104, 204, 304, 404, and 504 discussed above) to bear external hydrostatic pressure. The second pressure armor layer R2 may be a hoop reinforcement layer or a hoop strength layer and may provide additional resistance to internal pressure loading. In one or more embodiments, the second pressure armor layer R2 may be a composite helical wrap.

As shown in FIG. 6, the anti-collapse sheath E1 may be disposed between the first pressure armor layer R1 (e.g., layers 220, 320, 420, and 520) and the second pressure armor layer R2 (e.g., hoop strength layers 104, 204, 304, 404, and 504). In one or more embodiments, the anti-collapse sheath E1 may be formed from a thermoplastic material, which may include polyvinylidene fluoride (PVDF), polyethylene (PE), or polyamide (PA). However, those having ordinary skill in the art will appreciate that the anti-collapse sheath E1 may be formed from other thermoplastic materials and is not limited to being formed from PVDF, PE or PA.

Further, as shown, the flexible pipe 600 may also include tensile armor layers R3, R4, R5, and R6, anti-wear layers S0, S1, S2, and S3, anti-buckling tape S4 and S5, and an external sheath/jacket E2. In one or more embodiments, the tensile armor layers R3, R4, R5, and R6 may provide tensile reinforcement and tensile capacity. In one or more embodiments, two sets of tensile armor layers may be wound in opposite, helical directors to assure torque balance, such that R5 and R6 are not included in the flexible pipe. The tensile armor layers R3, R4, R5, and R6 and/or the second pressure armor layer R2 may be formed from a glass fiber or carbon fiber laminate. The anti-wear layers S0, S1, S2, and S3 may prevent wear of composite reinforcement due to contact/relative movement between adjacent layers of the flexible pipe 600. The anti-wear layers S0, S1, S2, and S3 may be formed from PE, PA, PVDF tape or another polymer tape. Finally, the external sheath/jacket E2 may protect the structure of the flexible pipe 600 against abrasion and mechanical damage.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A tubular assembly, comprising:
a fluid barrier layer; and
a pressure armor layer, the pressure armor layer comprising:
a first layer comprising at least one metallic layer, the first layer disposed external to the fluid barrier layer; and
a second layer comprising a plurality of composite helical wraps disposed external to the first layer.

2. The tubular assembly of claim 1, wherein the first layer comprises an anti-extrusion layer that resists extrusion of the fluid barrier layer.

3. The tubular assembly of claim 1, wherein the at least one metallic layer comprises one or more metallic strips.

4.-6. (canceled)

7. The tubular assembly of claim 1, wherein the at least one metallic layer comprises one or more shaped wires.

8. (canceled)

9. (canceled)

10. The tubular assembly of claim 1, wherein the at least one metallic layer of the first layer comprises a polymer tape having metallic fibers.

11.-13. (canceled)

14. The tubular assembly of claim 1, wherein the first layer comprises at least one protrusion disposed into a space between adjacent non-interlocked helical wraps of the second layer.

15. The tubular assembly of claim 1, wherein the at least one metallic layer of the first layer is an interlocked metallic layer.

16. (canceled)

17. (canceled)

18. A flexible pipe, comprising:
a fluid barrier layer;
a hoop strength layer comprising non-interlocked helical wraps; and
an anti-extrusion layer comprising at least one metallic layer, the anti-extrusion layer disposed between the fluid barrier layer and hoop strength layer that resists extrusion of the fluid barrier layer into gaps formed between the non-interlocked helical wraps of the hoop strength layer.

19. The flexible pipe of claim 18, wherein the at least one metallic layer comprises one or more metallic strips.

20. The flexible pipe of claim 18, wherein one or more gaps are formed between the one or more metallic strips of the at least one metallic layer.

21.-23. (canceled)

24. The flexible pipe of claim 18, wherein at least one of the metallic strips is step-shaped having a lower portion and an upper portion.

25. (canceled)

26. The flexible pipe of claim 18, wherein the at least one metallic layer of the first layer comprises a polymer tape having metallic fibers.

27. The flexible pipe of claim 19, wherein the at least one metallic strip comprises at least one protrusion disposed in one or more of the gaps formed between the non-interlocked helical wraps of the hoop strength layer.

28. (canceled)

29. (canceled)

30. The flexible pipe of claim 18, wherein the anti-extrusion layer comprises at least one protrusion disposed into a space between adjacent non-interlocked helical wraps of the hoop strength.

31. The flexible pipe of claim 18, wherein the at least one metallic layer of the anti-extrusion layer is an interlocked metallic layer.

32.-39. (canceled)

40. A flexible pipe, comprising:
a fluid barrier layer;
a first pressure armor layer; and
a second pressure armor layer; and
an anti-collapse sheath layer disposed between the first pressure armor layer and second pressure armor layer.

41. The flexible pipe of claim 40, wherein the first pressure armor layer comprises a metallic interlocked layer.

42. The flexible pipe of claim 18, further comprising an anti-collapse sheath layer disposed between the hoop strength layer and the anti-extrusion layer.

43. The flexible pipe of claim 40, wherein the second pressure armor layer comprises a hoop strength layer having non-interlocked helical wraps.

44. The flexible pipe of claim 43, wherein the second pressure armor layer comprises composite helical wraps.
